(19) United States
(12) Patent Application Publication
(10) Pub. No.: US 2026/0310792 A1
(43) Pub. Date: Oct. 8, 2026

(54) HOLISTIC ENTERPRISE RISK CONTROL SYSTEMS AND METHODS

(71) Applicant: PayPal, Inc., San Jose, CA (US)

(72) Inventors: Peifan Shi, Wuhan (CN); Yingwei Xin, San Jose, CA (US); Ravi Retineni, Fremont, CA (US); Soodong Park, Fort Lee, NJ (US); Sneha Venkatachalam, San Jose, CA (US); Zelin Yan, Shanghai (CN); Huiting Li, Shanghai (CN); Jun Chen, Shanghai (CN)

(21) Appl. No.: 19/172,365

(22) Filed: Apr. 7, 2025

(51) Int. Cl. G06F 21/57

(52) U.S. Cl. CPC G06F 21/577; G06F 2221/033

(57) ABSTRACT

Embodiments directed to risk control systems and methods are provided. The risk control system architecture includes a control module and a simulation module that are coupled to a graph dashboard displayed in a user interface. The control module receives a plurality of controls, including a first subset associated with a risk and a second subset not associated with the risk. The plurality of controls are prioritized. A simulation module simulates an improvement to a risk rating of the risk using the prioritized controls. Based on the simulation, a third set of controls from the prioritized controls and corresponding actions that improve the risk rating are determined. The graph dashboard on a user interface displays a node graph representing risks and corresponding controls in a computing environment. The graph dashboard receives input that selects a risk and initiating a simulation that improves the risk rating.

### FIELD OF INVENTION

The embodiments are directed to risk control systems, and more particularly to risk identification and simulation.

### BACKGROUND

The management of risks across multiple applications and systems has become increasingly complex in modern computing environments. As organizations expand their digital footprints, they face challenges in maintaining consistent risk control measures across diverse platforms and technologies. This complexity often leads to gaps in risk coverage, inconsistent application of risk controls, and difficulties in assessing the overall risk of a computing environment.

Traditional approaches to risk management often struggle to keep pace with rapidly evolving technological landscapes. The sheer volume of data generated by various systems, coupled with the interconnected nature of applications, creates challenges in identifying, prioritizing, and mitigating risks effectively. Moreover, the dynamic nature of threats requires continuous adaptation of risk control strategies, which can be resource-intensive and prone to human error when managed manually.

There is a growing need for advanced systems that can holistically analyze risks across multiple applications and identify appropriate control to mitigate the risks. Such systems would leverage data-driven insights to prioritize risks, simulate the impact of different control measures, and provide recommendations for improving overall risk posture. By automating these processes and providing a comprehensive view of risks and controls, computing environment could enhance its ability to protect against threats, optimize resource allocation, and maintain robust risk management practices across different technology stacks.

### BRIEF DESCRIPTION OF FIGURES

FIG. 1 illustrates a computing environment where the embodiments may be implemented.

FIG. 2 illustrates a block diagram of a risk control system, according to some embodiments.

FIG. 3 illustrates a block diagram of a control module architecture, according to some embodiments.

FIG. 4 illustrates a block diagram of a simulation module architecture, according to some embodiments.

FIG. 5 illustrates a graph dashboard depicting a graph with risks and controls, according to some embodiments.

FIG. 6 illustrates a graph dashboard which provides a visual representation of the relationships between a selected risk and controls, according to some embodiments.

FIG. 7 illustrates a sequence diagram depicting the interaction flow between various components for generating and updating a risk and control graph, according to some embodiments.

FIG. 8 illustrates a flowchart of a method for mitigating a risk, according to some embodiments.

FIG. 9 illustrates a block diagram of a computing system, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to a risk control system that addresses the challenges of managing risks across multiple applications and systems in one or more computing environments. These embodiments are directed to identifying applications and systems that incur high risk and proposing controls for mitigating and/or reducing the risk.

The embodiments are also directed to a graph dashboard interface that displays a node graph illustrating complex relationships between risks, controls, and entities within various computing environments. A risk may be selected by selecting one of the risk nodes, and a real-time simulation directed at identifying controls that reduce the risk level of the risk may be invoked. The simulation may prioritize controls for reducing the risk level by considering various factors such as control weight, applicability, and impact on multiple risks and entities. A set of proposed controls are then provided from the prioritized control for mitigating the risk using the optimal resource and cost allocation for implementing the controls. This approach may also help in identifying critical risks and controls, leading to a more efficient risk mitigation processes.

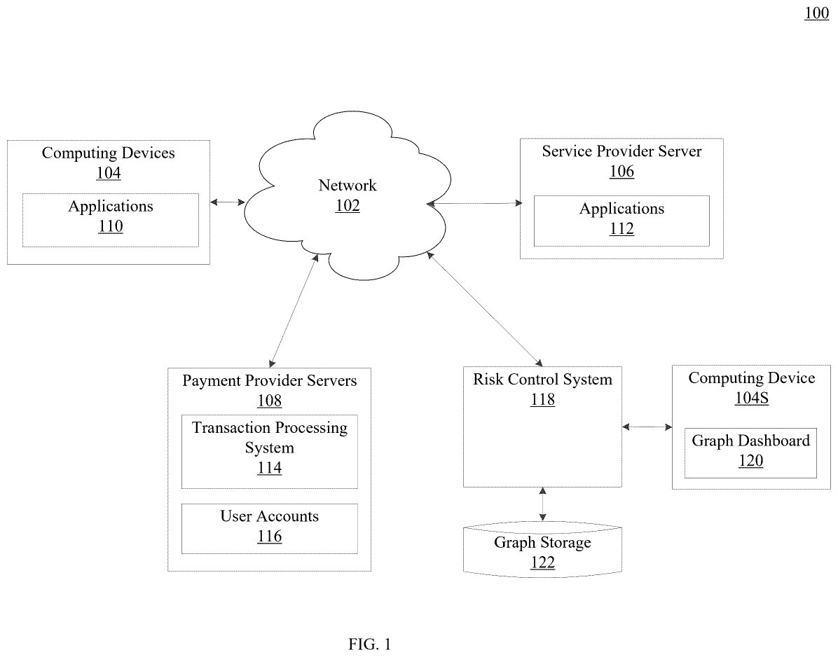

FIG. 1 is an exemplary computing environment 100 where embodiments can be implemented. Computing environment 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104, service provider server(s) 106, and payment provider server(s) 108. Computing devices 104 may be portable and non-portable electronic devices under the control of a user and configured to transmit, receive, and manipulate data from service provider server(s) 106 and payment provider server(s) 108 over network 102. Example computing devices 104 include desktop computers, laptop computers, tablets, smartphones, wearable computing devices, eyeglasses that incorporate computing devices, implantable computing devices, etc.

Computing devices 104 may include one or more applications 110. Applications 110 may be pre-installed on the computing devices 104, installed on the computing devices 104 using portable memory storage devices, such as compact disks or thumb-drives, or be downloaded to the computing devices 104 from service provider server(s) 106 and/or payment provider server(s) 108. Applications 110 may execute on computing devices 104 and receive instructions and data from a user, from service provider server(s) 106, and payment provider server(s) 108.

Example applications 110 may be payment transaction applications. Payment transaction applications may be configured to transfer money world-wide, receive payments for goods and services, manage money spending, etc. Further, applications 110 may be under an ownership or control of a payment service provider, such as PAYPAL®, Inc. of San Jose, CA, USA, a telephonic service provider, a social networking service provider, and/or other service providers. Applications 110 may also be analytics applications. Analytics applications perform business logic, provide services, and measure and improve performance of services and functions of other applications that execute on computing devices 104 based on current and historical data. Applications 110 may also be security applications for implementing client-side security features, programmatic client applications for interfacing with appropriate application programming interfaces (APIs) over network 102, communication applications, such as email, texting, voice, and instant messaging applications that allow a user to send and receive emails, calls, texts, and other notifications through network 102, and the like. Applications 110 may be location detection applications, such as a mapping, compass, and/or global positioning system (GPS) applications, social networking applications and/or merchant applications. Additionally, applications 110 may be service applications that permit a user of computing device 104 to receive, request and/or view information for products and/or services and permit the user to purchase the selected products and/or services.

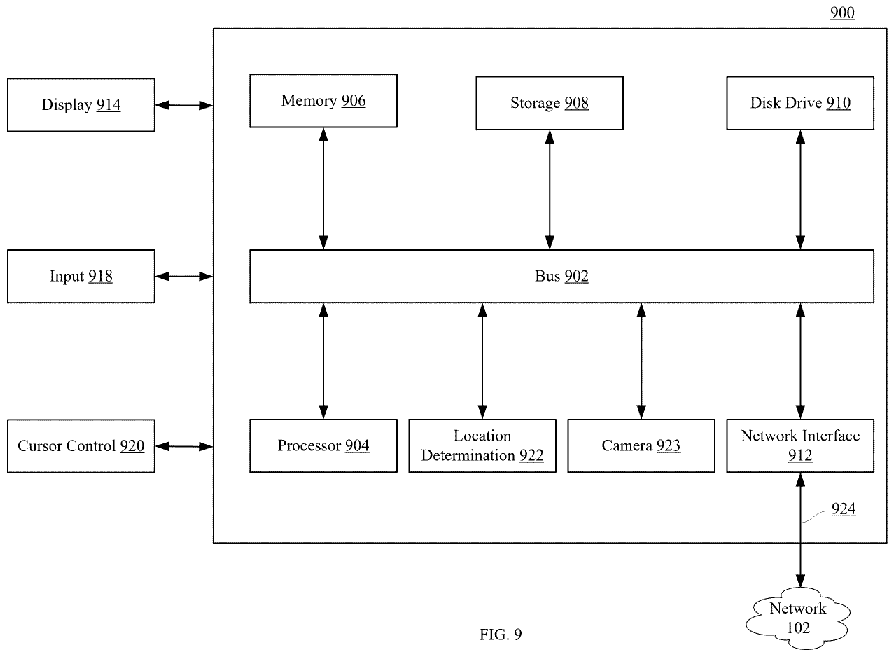

In an embodiment, applications 110 may utilize numerous components included in computing device 104 to receive input, store and display data, and communicate with network 102. Example components are discussed in detail in FIG. 9.

As discussed above, one or more service provider servers 106 may be connected to network 102. Service provider server 106 may also be maintained by a service provider, such as PAYPAL®, a telephonic service provider, social networking service, and/or other service providers. Service provider server 106 may be software that executes on a computing device configured for large scale processing and that provides functionality to other computer programs, such as applications 110 and applications 112 discussed below.

In an embodiment, service provider server 106 may initiate and direct execution of applications 112. Applications 112 may be counterparts to applications 110 executing on computing devices 104 and may process transactions at the requests of applications 110. For example, applications 112 may be financial services applications configured to transfer money world-wide, receive payments for goods and services, manage money spending, etc., that receive message from the financial services applications executing on computing device 104. Applications 112 may be security applications configured to implement client-side security features or programmatic client applications for interfacing with appropriate application programming interfaces (APIs) over network 102. Applications 112 may be communication applications that perform email, texting, voice, and instant messaging functions that allow a user to send and receive emails, calls, texts, and other notifications over network 102. In yet another embodiment, applications 112 may be location detection applications, such as a mapping, compass, and/or GPS applications. In yet another embodiment, applications 112 may also be incorporated into social networking applications and/or merchant applications.

In an embodiment, applications 110 and applications 112 may process transactions on behalf of a user. In some embodiments, to process transactions, applications 110, 112 may request payments for processing the transactions via payment provider server(s) 108. For instance, payment provider server 108 may be a software application that is configured to receive requests from applications 110, 112 that cause the payment provider server 108 to transfer funds of a user using application 110 to service provider associated with application 112. Thus, applications 110 and 112 may receive user data, including user authentication data, for processing any number of electronic transactions, such as through payment provider server 108.

In an embodiment, payment provider servers 108 may be maintained by a payment provider, such as PAYPAL®. Other payment provider servers 108 may be maintained by or include a merchant, financial services provider, credit card provider, bank, and/or other payment provider, which may provide user account services and/or payment services to a user. Although payment provider servers 108 are described as separate from service provider server 106, it is understood that one or more of payment provider servers 108 may include services offered by service provider server 106 and vice versa.

Each payment provider server 108 may include a transaction processing system 114. Transaction processing system 114 may correspond to processes, procedures, and/or applications executable by a hardware processor. In an embodiment, transaction processing system 114 may be configured to receive information from one or more applications 110 executing on computing devices 104 and/or applications 112 executing on service provider server 106 for processing and completion of financial transactions. Financial transactions may include financial information corresponding to user debit/credit card information, checking account information, a user account (e.g., payment account with a payment provider server 108), or other payment information. Transaction processing system 114 may complete the financial transaction for the purchase request by providing payment to application 112 executing on service provider server 106.

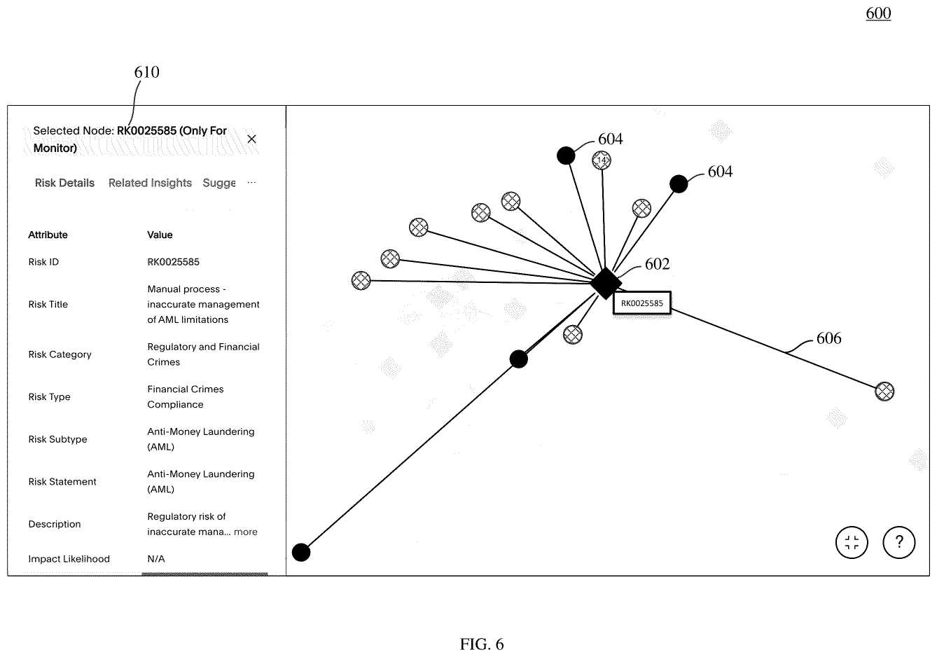

Payment provider server 108 may also include user accounts 116. Each user account 116 may be established by one or more users using applications 110 with payment provider server 108 to facilitate payment for goods and/or services offered by applications 112. User accounts 116 may include user information, such as name, address, birthdate, payment/funding information, travel information, additional user financial information, and/or other desired user data. In a further embodiment, user accounts 116 may be stored in a database or another memory storage described in detail in FIG. 6. In some instances, payment provider server 108 may also include user accounts 116S. User accounts 116S may be established on behalf of service provider or a merchant that is associated with applications 112 executing on service provider server 106.

In some embodiments, computing devices 104 that execute applications 110, payment providers servers 108, and applications 112 that execute on server provider servers 106, and the connection of these components over network 102 may constitute computing environment 100. A user may use application 110 of computing device 104 and service providers may use computing devices 104S to interact with the computing environment 100. For example, users and service providers may enter user credentials into a graphical user interface that may be displayed on applications 110, 112 and log-in or access the computing environment 100. User may use application 110 to perform actions, such as browse products or services available on application 110, select one or more products or services, and/or purchase the selected one or more products or services. Similarly, a service provider may use application 112 to access services available by payment provider server 108 or by transaction processing system 114. As various users, applications 110, 112, transaction processing systems 114, and the like execute within computing environment 100, these components and their sub-components may be associated with various levels of risk. The risks may be risks of malfunction, resource allocation risk (e.g., insufficient memory, processing power, network bandwidth, connectivity risk, etc.), fraud risk, software update risk, and the like. Other examples of risks may be associated with integrity, confidentiality, and availability of systems and data. These risks include components of computing environment 100 being infected with malware and viruses, which can lead to data breaches and system downtime. Another example of risks may include unauthorized access, which can result in data theft and misuse. Another example of risk may include data loss due to hardware failure or cyber-attacks. Another example risk may include phishing attacks that trick users into revealing sensitive information, denial of service (DoS) attacks that overwhelm systems, physical security breaches leading to theft or damage of hardware, and software vulnerabilities that can be exploited by attackers.

To mitigate the various risks in a computing environment, a range of controls may be implemented for one or more risks. Some example controls may be including antivirus software, keep systems updated, risk recognition, and the like. To prevent unauthorized access, multi-factor authentication, role-based access control, and audits may be employed. Risks of data loss may be mitigated using regular backups, data encryption, and a disaster recovery plan. Phishing attacks directed to tricking a user into revealing proprietary and/or sensitive information through deceptive electronic mail messages, text messages, and calls may be controlled using email filtering, user training, and incident response plans. Risks due to defend against denial of service (DoS) attacks directed to overwhelming a computing device or a server with network requests and disrupting a service and/or application as a result may be controlled using firewalls, intrusion detection/prevention systems, load balancing, and redundancy. Software vulnerabilities may be controlled through patch management, regular vulnerability scanning, and secure development practices. Resource allocation risk maybe controlled by identifying resource deficiencies and either freeing up or accessing additional resources. Software updated may be controlled using multiple testing environments, logging systems, and alerts. These comprehensive controls help safeguard systems and data from a wide array of threats.

Computing environment 100 may include a risk control system 118. The risk control system 118 may be connected to the communication network 102, allowing the risk control system 118 to interact and collect data, including risks and corresponding controls from various components in the computing environment 100. The risk control system 118 may be coupled to computing device 104S associated with an entity, such as an entity that controls payment provider servers 108. Computing device 104S may include a user interface that generates and/or displays a visual graph dashboard 120. The visual graph dashboard 120 depicts a graph that displays relationships between risks and controls for different entities that may be generated by risk control system 118 or by computing device 104S. The visual graph dashboard 120 may display nodes and edges, where nodes display a risk and corresponding controls, and indicate a risk rating for each risk. The risk rating provides a visual way to identify risks that have a high-risk rating and those that do not to visually identify and prioritize high risks.

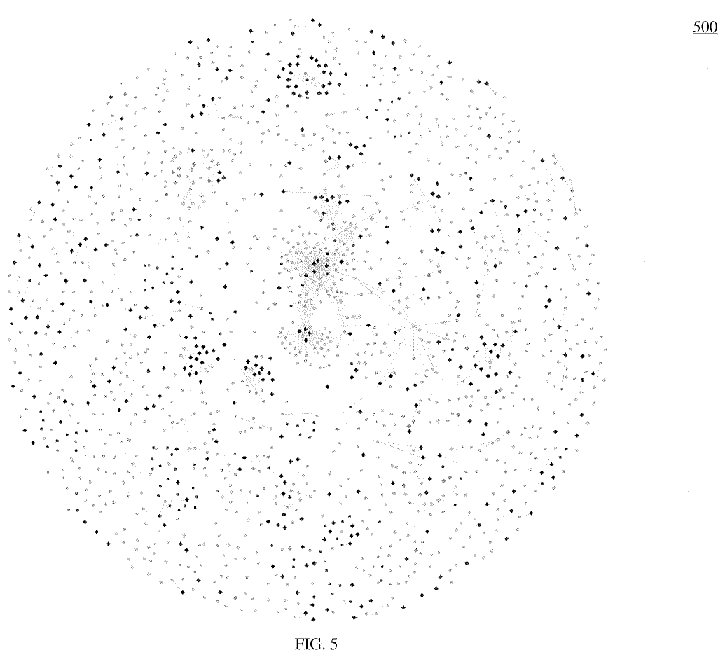

In some implementations, the risk control system 118 may be connected to a graph storage 122. The graph storage 122 may store risk and control information collected from various components within the computing environment 100. This information may include data about identified risks, risk attributes, implemented and available controls, control attributes, relationships among risks and controls, and associated metadata. The risk control system 118 may utilize this stored information to generate a comprehensive risk and control graph that is displayed on graph dashboard 120. This graph may represent the complex interconnections between risks, controls, and entities within the computing environment 100 and is discussed in further detail in FIGS. 5 and 6. The generated graph may be displayed on the graph dashboard 120, providing users with a visual representation of the risk landscape. The graph dashboard 120 may allow users to interact with the displayed graph, enabling them to explore relationships, assess risk levels, and evaluate control effectiveness across different entities and systems within the computing environment 100.

To improve a risk rating for a risk, the risk control system 118 may simulate controls that are connected to the risk and available controls that are not connected to the risk. The simulation may identify controls that improve the risk rating. In some cases, the inherent risk rating and residual risk rating may be two factors considered when prioritizing risks. To simulate the impact of different controls on a risk residual rating of the risk, the risk control system 118 may evaluate one or more controls using control features such as control weight, control strength, number of linked issues. For different controls, risk control system 118 may calculate the new risk residual rating. In some embodiments, the entire simulation process may be real-time.

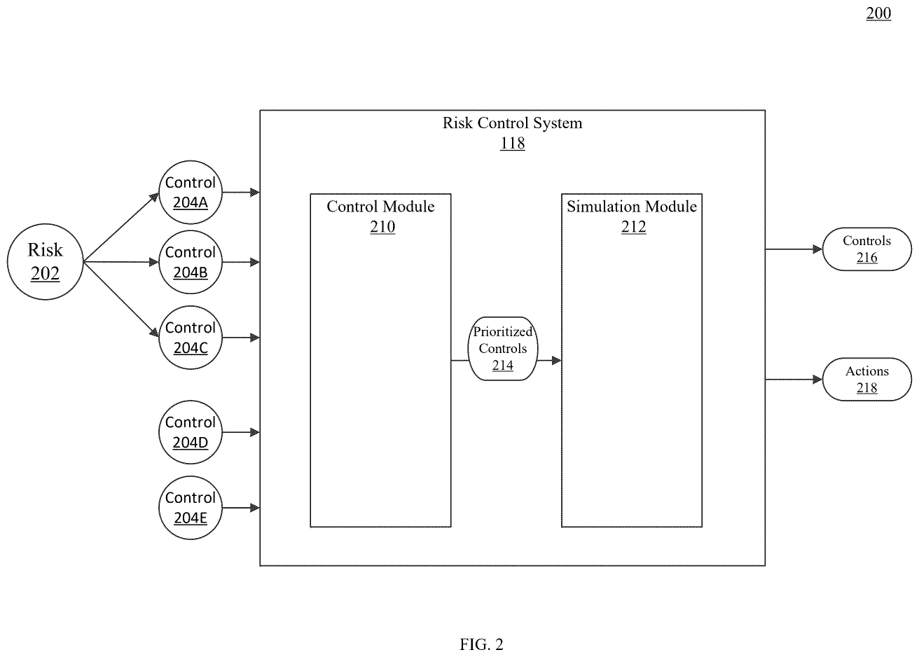

FIG. 2 illustrates a risk control system architecture 200 of the risk control system 118. The risk control system architecture 200 may receive risks, such as, an example risk 202 and controls 204 that may improve the risk rating of the risks, such as risk 202. Risk 202 may be associated with controls 204A, 204B, and 204C. Additionally, risk control system 118 may receive controls that are not associated with risk 202, such as controls 204D and 204E, but that risk control system 118 may consider for improving the risk rating of risk 202.

The connections between risk 202 and controls 204A-C may represent existing risk mitigation strategies or control measures that have been identified as potentially effective for addressing risk 202. These connections may be established based on various factors such as historical data, expert knowledge, or automated analysis of control effectiveness. The risk control system 118 may analyze these connected controls during the simulation process to identify if they can be optimized to provide additional risk reduction benefits if applied to risk 202.

Controls 204D and 204E, while not directly connected to risk 202, may be used to mitigate the risk rating. In some cases, these unconnected controls may represent potential additional measures that could be implemented to further mitigate risk 202. The risk control system 118 may analyze these unconnected controls during the simulation process to identify if they could provide additional risk reduction benefits if applied to risk 202. In some instances, risk control system 118 may select the unconnected controls 204 to improve the risk rating.

By maintaining a distinction between connected and unconnected controls, the risk control system 118 may be able to perform more nuanced analyses. For instance, it may compare the effectiveness of currently implemented controls (204A-C) against potential new controls (204D-E) or a combination of some or all currently implemented controls 204A-C and potential new controls 204D-E to determine if changes in the control(s) may lead to improved risk mitigation for risk 202. This approach may enable the risk control system 118 to provide more comprehensive and dynamic recommendations in real-time for enhancing overall risk strategies.

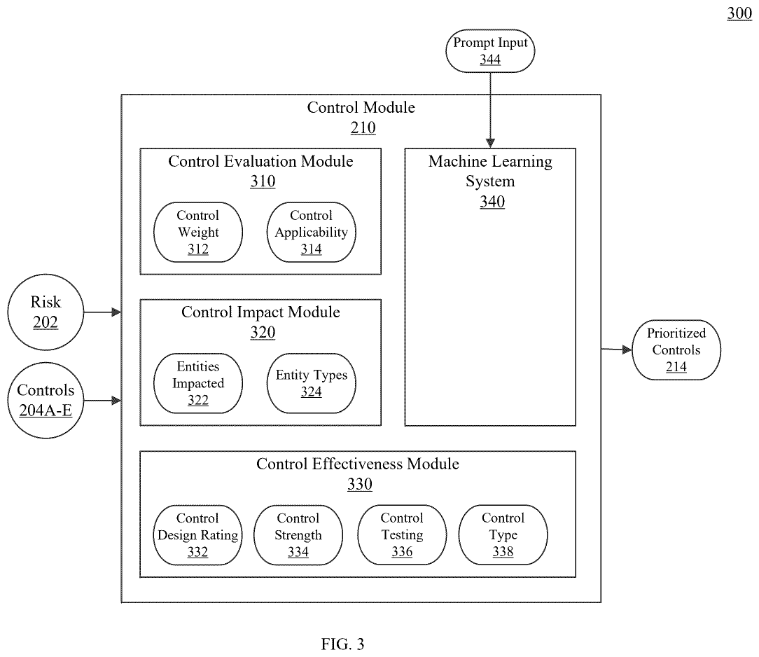

Risk control system 118 may include a control module 210 and a simulation module 212. The control module 210 may be coupled to simulation module 212. Control module 210 may receive controls associated with risk 202 (e.g., controls 204A-C) and controls not associated with risk 202 (e.g., controls 204D-E), process control features of controls 204A-204E and generate prioritized controls 214 based on the processing of the controls 204A-E. In some instances, prioritized controls may include a subset of controls 204A-E (not shown). The prioritized controls 214 may be provided as input to the simulation module 212. Control module 210 is further discussed in FIG. 3.

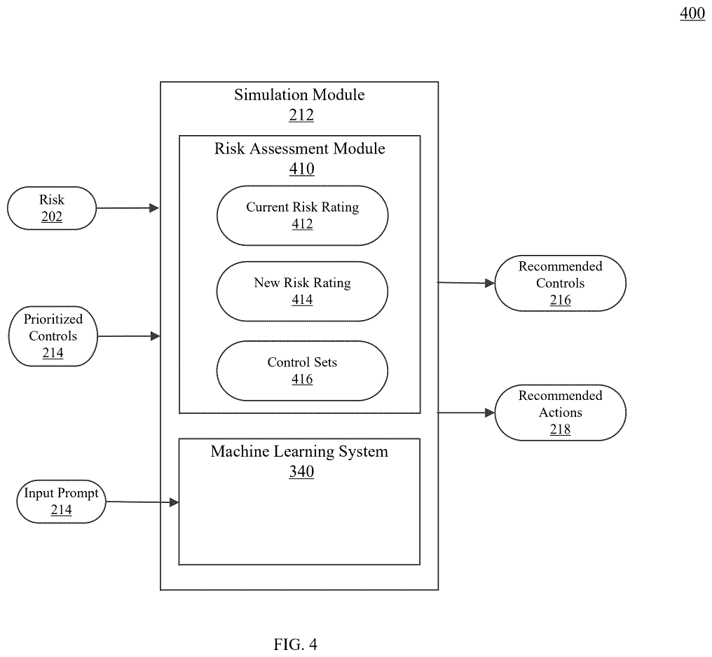

The simulation module 212 may analyze the prioritized controls 214 to generate recommended controls 216 and recommended actions 218. The recommended controls 216 may suggest a set of controls to implement to reduce a risk rating of risk 202. The recommended actions 218 may provide guidance on steps to take to enhance risk mitigation. Simulation module 212 is further discussed in FIG. 4.

FIG. 3 illustrates a control module architecture 300 of the control module 210. The control module architecture 300 may include a control evaluation module 310, a control impact module 320, a control effectiveness module 330, and a machine learning system 340. The control module 210 may receive risks and prioritize controls that may reduce the risk rating corresponding to the risk. The embodiments below describe control module architecture 300 prioritizing controls 204A-E for risk 202, though the embodiments may also apply to other risks and controls.

Controls 204A-E may include control attributes. The control evaluation module 310 may assess control attributes associated with each control in a controls 204A-E. In some cases, the control attributes may include a control weight 312 with respect to risk 202 and a control applicability 314 to the risk 202. The control weight 312 may represent the relative importance or influence of a control on mitigating the risk 202 and may be set based on historical control data or expert knowledge. The control applicability 314 may indicate how relevant or suitable a control is for addressing the specific risk 202 and may also be set based on historical control data or expert knowledge.

The control impact module 320 may analyze the impact of each control in controls 204A-E on various entities within the computing environment 100. These entities may include different applications and systems used by computing environment 100. In some embodiments, a combination of applications 110, 112 associated with a particular service provider server 106 and their connectivity to transaction processing system 114 may constitute an entity. In addition various components within entities may be impacted by controls, including data analytics tools, cloud storage services, electronic mail and collaboration platforms, network security appliances, mobile device management systems, and/or components thereof. In some cases, the control impact module 320 may assess a number of entities impacted 322 by each control in controls 204A-E and types of entities impacted 324 by each control in controls 204A-E. This assessment may help prioritize controls 204A-E based on their broader influence across the computing environment 100. In some cases, a single control may impact multiple components simultaneously. For instance, a data encryption control may affect both the cloud storage service and the financial management software. The control impact module 320 may assess the number of entities impacted 322 by each control 204A-E, which could range from a single application to dozens of interconnected systems. Additionally, the types of entities impacted 324 may be categorized based on their function, criticality, or data sensitivity level.

The control effectiveness module 330 may evaluate the overall effectiveness of each control in controls 204A-E for mitigating risk 202. In some cases, the control effectiveness module 330 may consider factors such as control design rating 332, control strength 334, control testing 336, and control type 338. The control design rating 332 may assess how well a control is designed to address the risk 202. Control strength 334 may reflect whether the control is strong enough to mitigate the risk 202. In some instances, the control strength 334 may correspond to a number of entities for which control 204 may mitigate risks. A control with the same control strength 334 may mitigate a risk for ten components but may not mitigate the same risk for 100 components due to, e.g., resource constraints. The control testing 336 may indicate whether the control is working as expected. The control type 338 may categorize the control based on its characteristics or implementation method.

In some instances, control evaluation module 310, control impact module 320, and control effectiveness module 330 may assign scores to the respective control features. The scores may be based on each control's potential capacity to mitigate risk, the number of risks that controls have mitigated, whether a control is linked to open issues or is untested, and/or whether a control is liked to an entity or a product. Control module 210 may combine the scores generated by control evaluation module 310, control impact module 320, and control effectiveness module 330 and generate prioritized controls 214 for mitigating risk 202. The prioritized controls 214 may represent a ranked list of controls based on their potential effectiveness in mitigating the risk 202. An example list may be from the most effective to the least effective. By utilizing the control module architecture 300, the risk control system 118 may prioritize the plurality of controls based on various factors and assessments. This prioritization process may enable the risk control system 118 to identify the most effective controls for addressing specific risks 202 within the computing environment 100. In some instances, prioritized controls 214 may include a top n controls, where n identifies the maximum number of controls that may be included in prioritized controls 214.

Control module 210 may also include or be communicatively coupled to machine learning system 340. Machine learning system 340 may incorporate generative AI capabilities to determine prioritized controls 214 or to explain various features of prioritized controls 214. In some cases, the machine learning system 340 may utilize large language models (LLMs) or transformer-based models like BERT (Bidirectional Encoder Representations from Transformers) to generate explanations for the features. Machine learning system 340 may recurrent neural networks (RNNs) or long short-term memory (LSTM) networks to analyze time-series data corresponding to controls 204A-E, which may be useful for identifying patterns in historical risk events or control effectiveness over time.

The machine learning system 340 may receive prompt input 344. Prompt input 344 may include outputs from the control evaluation module 310, control impact module 320, and control effectiveness module 330. In some cases, prompt input 344 may also incorporate control attributes and/or results of previous simulations for risk 202, if available. Upon receiving the prompt input 344, the machine learning system 340 may analyze and process this information to prioritize controls 204A-E, generating prioritized controls 214 as output. The prioritization of controls may be arranged in various orders, such as from most effective to least effective or vice versa, depending on the specific requirements of the risk control system 118. This prioritization process may enable the risk control system 118 to efficiently identify and recommend the most suitable controls for mitigating risk 202 based on comprehensive analysis of multiple factors and historical data.

Machine learning system 340 may also cross-reference the prioritized controls generated by machine learning system 340 and prioritized controls generated by other components in control module 210 to determine optimal prioritized controls 214. This cross-referencing process may validate prioritized controls 214 and identify discrepancies in generating prioritized controls 214. For example, by comparing the outputs of two different approaches (machine learning system 340 and other components in control module 210), prioritized controls 214 may be validated. In another example, any discrepancies between the machine learning system 340's outputs and those of the other components may be flagged for further review. These discrepancies may highlight areas where one approach may have identified potential solutions or risks that the other missed.

Once prioritized controls 214 are identified, prioritized controls 214 are passed to simulation module 212.

FIG. 4 illustrates a simulation module architecture 400 of the simulation module 212. The simulation module architecture 400 may include a risk assessment module 410. The risk assessment module 410 may be configured to evaluate and analyze risk ratings associated with risks in the computing environment 100 and identify control sets 416 from prioritized controls 214 that may mitigate the risks, such as risk 202.

The risk assessment module 410 may receive risk 202 and prioritized controls 214 as inputs. Based on the risk attributes associated with risk 202, the risk assessment module 410 may determine the current risk rating 412. This current risk rating 412 may serve as a baseline for evaluating potential improvements for mitigating the risk rating of the risk 202. The current risk rating 412 may represent the risk rating associated with risk 202 given existing controls. For example, with respect to risk 202, current risk rating 412 may be based on controls 204A-C that are associated with risk 202 and their corresponding attributes.

In some aspects, the risk assessment module 410 may analyze different combinations of controls from the prioritized controls 214 to determine a potential new risk rating 414. These different combinations of controls may be represented as control sets 416. Each control set 416 may consist of a unique combination of controls that could potentially be applied to mitigate current risk rating 412 of risk 202. In some instances, the combinations of controls may be based on existing controls 204A-C with different control attributes. In other instances, the combinations of controls may be based on one or more existing controls 204A-C and one or more new controls 204D-E. In yet other instances, the combinations of controls may include all new controls, such as controls 204D-E.

The risk assessment module 410 may evaluate the impact of each control set 416 on the risk rating, generating corresponding new risk ratings 414. This process may involve simulating the application of each control set 416 to risk 202 and calculating the resulting risk rating based on various factors and algorithms implemented within the risk assessment module 410.

After analyzing multiple control sets 416 and their corresponding new risk ratings 414, the risk assessment module 410 may identify the most efficient combination of controls. This efficiency may be determined based on factors such as the degree of risk reduction, implementation costs, resource requirements, or other relevant criteria defined within the system.

The control set identified as most efficient may then be recommended by the risk assessment module 410 as the recommended controls 216 for mitigating risk 202. These recommended controls 216 may represent the optimal balance between risk reduction and resource utilization based on the analysis performed by the risk assessment module 410.

In some cases, the risk assessment module 410 may utilize a formula for calculating a current risk rating 412. This formula may be based on a combination of factors, including an inherent risk rating of risk 202 and residual risk rating for risk 202. The inherent risk rating for risk 202 may be a set feature of risk 202. The residual risk rating may be determined as follows:

$$CER = SUM ( {Weight}_{i} [ {strength}_{h} + {applicability}_{i} ] / 2 * {Factor}_{{issue}_{i}} * {Factor}_{{test}_{i}} * 0 \text{.6} )$$

$$ResidualRisk = InherentRisk ( 1 - CER )$$

The residual risk rating may correspond to current risk rating 412. In the embodiment above, strength; may be control strength 334 of the controls 204A-C and applicabilityᵢ may be control applicability 314 of one of controls 204A-C (controlᵢ) that are currently associated with risk 202.

Once the current risk rating 412 is determined, the current risk rating 412 may be assigned to a risk level. For example, risk ratings may fall within a risk range, such as a risk range with values between 0 and 100. The risk range may be divided into risk levels, such as low risk, moderate risk, moderately high risk, and high risk. Each of the risk levels may correspond to a range of numerical values within the risk range. For exemplary purposes only, the low risk may be between 0-22, moderate risk may be between 22-50, moderately high risk may be between 50-75, and high risk may be between 75-100.

The risk assessment module 410 may access at least one new risk rating 414 by generating different control sets 416. The process may be iterative an involve multiple iterations. For example, to generate the first control set in control sets 416, risk assessment module 410 may identify a target risk level that is lower than the risk level corresponding to the current risk rating 412. The target risk level may be the next lowest level, such as if the current risk rating 412 corresponds to a moderate, the next lowest risk level may be low risk. In another example, if the current risk rating 412 corresponds to a high risk, the next lowest risk level may be moderately high risk, and the like. Risk assessment module 410 may also generate different control sets 416, where different control sets 416 may correspond to new risk ratings 414 at different target risk levels. For example, if the current risk rating 412 corresponds to a high-risk level, new risk ratings 414 for different control sets 416 may corresponds to moderately high risk, moderate risk, and/or low risk or to multiple ranges within the one or more risk levels.

Once the risk assessment module 410 identifies the target risk level, risk assessment module 410 may calculate the mitigation target. The mitigation target may be the difference between the current risk rating 412 (e.g., residual risk (RR) score) and the new risk rating 414 corresponding to the target level. For example, suppose current risk rating 412 for risk 202 is 38 (moderate risk) and the target level is the next lower level (low risk) which as an upper bound of 22. In this case, the mitigation target may be 16 points (38−22=16). Second, risk assessment module 410 may optimizing top controls that are associated with risk 202, but are not yet optimized with respect to risk 202. An example top control may be control 204A. This may involve adjusting various control factors associated with control 204A to enhance its effectiveness. After optimizing control 204A, the risk assessment module 410 may update the new risk rating 414 by subtracting the impact score of the optimized control 204A from current risk rating 412. For instance, an optimized control 204A may reduce the current risk rating 412 by 12 points, making the new risk rating 414 be 26 (38−12=26). Risk assessment module 410 may then select the next control for optimization. Instead of selecting one of controls associated with risk 202, because, e.g., all controls 204A-C have been optimized, risk assessment module 410 may select control 204E. Risk assessment module 410 may then determine the number of points by which control 204E reduces the new risk rating 414. This process may be repeated, with each iteration involving control optimization, factor adjustment, and current risk rating 412 update, until the new risk rating 414 reaches the target level. For example, suppose control 204E reduces the new risk rating 414 by 5 points, causing the new risk rating 414 to be 21. Because the new risk rating 414 reached the target level, risk assessment module 410 identified a control set 416 that includes controls 204A-C and 204E. In another example, suppose control 204E reduces the new risk rating 414 by 3 points, causing the new risk rating 414 to be 23. In this case, risk assessment module 410 may either identify another control, e.g., control 204D or change control attributes of control 204E before recalculating the new risk rating 414.

Using the iterative process above, risk assessment module 410 may generate different control sets 416 with each control set having new risk rating 414 at different target levels. Risk assessment module 410 may then select one of control sets 416 as recommended controls 216. The recommended controls 216 may suggest specific controls or combinations of controls that are most effective in reducing the risk rating. The recommended controls 216 may strike a balance with the resources and cost that controls in each control set 416 may use to reach the target level and the tolerance of the new risk rating 414 of risk 202 by the computing environment 100.

In some cases, the simulation module 212 may include or be coupled to machine learning system 340. Machine learning system 340 may receive different input prompts 418. An example input prompt 418 may include sets of control 416 and generate an output that includes different control features and control characteristics. In another example, input prompt 418 may identify risk levels that may be acceptable for risk 202.

In some aspects, input prompt 418 may include control sets 416 along with associated resource requirements and cost information for each control within the control sets 416. The machine learning system 340 may analyze this information to select recommended controls 216 from control sets 416. During this process, the machine learning system 340 may consider factors such as the potential risk reduction offered by each control set, the resources required for implementation, and the associated costs. By evaluating resources and costs, the machine learning system 340 may identify recommended controls 216 that offer an optimal balance between risk mitigation effectiveness and resource efficiency.

In some cases, input prompt 418 may include recommended controls 216 generated by the risk assessment module 410. The machine learning system 340 may analyze these recommended controls 216 to generate corresponding recommended actions 218. This process may involve evaluating various control factors associated with the recommended controls 216, such as control weight, applicability, strength, and testing status. The recommended actions 218 may provide guidance on implementing the recommended controls or taking other steps to mitigate the risk 202 based on control and risk attributes.

In some aspects, the machine learning system 340 may consider the interdependencies between different recommended controls 216 when generating recommended actions 218. This may involve identifying synergies between controls and suggesting actions that maximize the combined impact of multiple controls on risk mitigation.

The machine learning system 340 may also take into account the current state of the computing environment 100 when generating recommended actions 218. For instance, if a control in recommended controls 216 is not yet implemented, the system may suggest a phased approach for introduction and integration into existing computing environment 100. Conversely, for controls already in place, the recommended actions 218 may focus on optimization and enhancement strategies.

In some aspects, the machine learning system 340 may receive input prompt 418 that includes prioritized controls 214. Based on this input, the machine learning system 340 may generate control sets 416 and recommended controls 216 using various machine learning algorithms and techniques, and control attributes of prioritized controls 214.

The machine learning system 340 may analyze the prioritized controls 214 to identify potential combinations that could effectively mitigate risk 202 to a new target level. This process may involve evaluating the attributes of each control, such as control weight, applicability, strength, and testing status, to determine how different combinations might impact the risk rating.

Once the machine learning system 340 has generated its control sets 416 and recommended controls 216, these outputs may be cross-referenced against those produced by the risk assessment module 410. This cross-referencing process may serve several purposes including validation, identification of discrepancies, and refining recommendations. For example, by comparing the outputs of two different approaches (machine learning system 340 and risk assessment module 410), recommended controls 216 may be validated. In another example, any discrepancies between the machine learning system 340's outputs and those of the risk assessment module 410 may be flagged for further review. These discrepancies may highlight areas where one approach may have identified potential solutions or risks that the other missed.

Going back to FIG. 1, the risk control system 118 may be coupled to computing device 104S. Computing device 104S may generate a graph dashboard 120 displayed on a user interface. Graph dashboard 120 may display risks and nodes associated with the risks that exist in computing environment 100. FIG. 5 illustrates graph dashboard 500, which may provide a visual representation of the relationships between risks and controls within the computing environment 100.

Graph dashboard 500 may include a cluster of nodes representing risks and controls, with edges connecting the nodes to indicate relationships and weights between the risks and controls. The nodes in the graph dashboard 500 may be displayed using different shapes to distinguish between risks and controls. For example, risk nodes may be represented by diamond shapes, while control nodes may be depicted as circles.

The color of the nodes in the graph dashboard 500 may convey additional information. For risk nodes, the color may correspond to the risk level (e.g., low risk, moderate risk, moderately high risk, high risk, and not rated) of the risks. This color-coding may allow for quick identification of high risks and differentiation between various types of risks within the computing environment 100. For control nodes, the color may indicate whether a control was tested or optimized for the associated risk. This visual cue may help users assess the level of verification for each control.

The edges connecting the nodes in the graph dashboard 500 may be represented by lines with varying attributes to indicate different characteristics of the relationships between risks and controls. In some cases, the thickness or color of an edge may represent the weight of a control's impact on a risk. Thicker or color coded lines may indicate a stronger influence or more significant impact of the control on the associated risk. In some embodiments, the color of the edges may corresponds to whether the control corresponding to the edge has been optimized, mitigating, partially mitigating, or non-mitigating.

By utilizing these visual elements, the graph dashboard 500 may provide a comprehensive and intuitive representation of the risk and control echo system within the computing environment 100. Further graph dashboard 500 may be used to identify high-risk areas, assess the effectiveness of controls, and understand the relationships between various components of the risk management system.

In some cases, the graph dashboard 500 may be interactive, allowing users to select specific nodes or edges to view more detailed information about risks, controls, or their relationships. This interactivity may enhance the usability of the graph dashboard 500 and provide users with deeper insights into the risk control system 118.

In some instances, graph dashboard 500 may also include a filter (not shown). The filter may filter the graph shown in the graph dashboard by risk rating, risk category, risk entity, assessment state, and the like.

FIG. 6 illustrates a graph dashboard 600, which may provide a visual representation of the relationships between a selected risk and controls within the computing environment 100. As illustrated in FIG. 6, a risk node 602 may be positioned centrally within the interface. The risk node 602 may represent a risk selected from the graph dashboard 500. Surrounding the risk node 602, the graph dashboard 600 may display multiple control nodes 604. Each of the control nodes 604 may represent a control associated with the risk at the selected risk node 602.

Graph dashboard 600 may include connections 606 between the risk node 602 and the control nodes 604. These connections 606 may be represented by lines extending from the central risk node 602 to each of the surrounding control nodes 604. In some cases, the thickness of a connection 606 may indicate the weight or importance of the corresponding control in mitigating the selected risk.

Graph dashboard 600 may also include an information panel 610. The information panel 610 may be positioned on one side of the interface, such as the left side. When a user selects a node, such as risk node 602, in graph dashboard 600, the information panel 610 may display detailed information about the risk corresponding to the selected node. For a risk node 602, this information may include risk attributes such as a risk identifier, risk title, risk category, risk type, risk subtype, risk statement, description, and impact likelihood. Additionally, information panel 610 may also identify a corresponding risk level (not shown), including inherent risk and residual risk, and a number of controls that are mapped to the risk. Similarly, for control nodes 604, the information panel 610 may show relevant control attributes (not shown).

In some cases, the risk control system 118 may allow a user to select a connection 606 between the risk node 602 and a control node 604. Upon selection of a connection 606, the information panel 610 may display detailed information about the relationship represented by the selected connection 606. This information may include details about how the control impacts the risk, the control's effectiveness, or other relevant data.

Graph dashboard 600 may receive instructions that initiate a simulation of the risk. For example, graph dashboard 600 may select the risk node 602 and choose an option to start a simulation. In response, the risk control system 118 may perform a simulation to identify new controls or control sets that may mitigate the risk and/or provide recommendations to optimize existing controls. Following the simulation, the risk control system 118 may update the graph dashboard 600 to display a user interface panel. This panel may identify a set of controls recommended by the simulation and corresponding actions determined to improve the risk rating. The recommended controls may be displayed as new control nodes 604 in the interface, or they may be highlighted within the existing control nodes 604.

By providing this interactive and detailed view of risks and controls, the graph dashboard 600 may enable users to gain deeper insights into the relationships between risks and controls, assess the effectiveness of current control measures, and explore potential improvements to risk mitigation strategies within the computing environment 100.

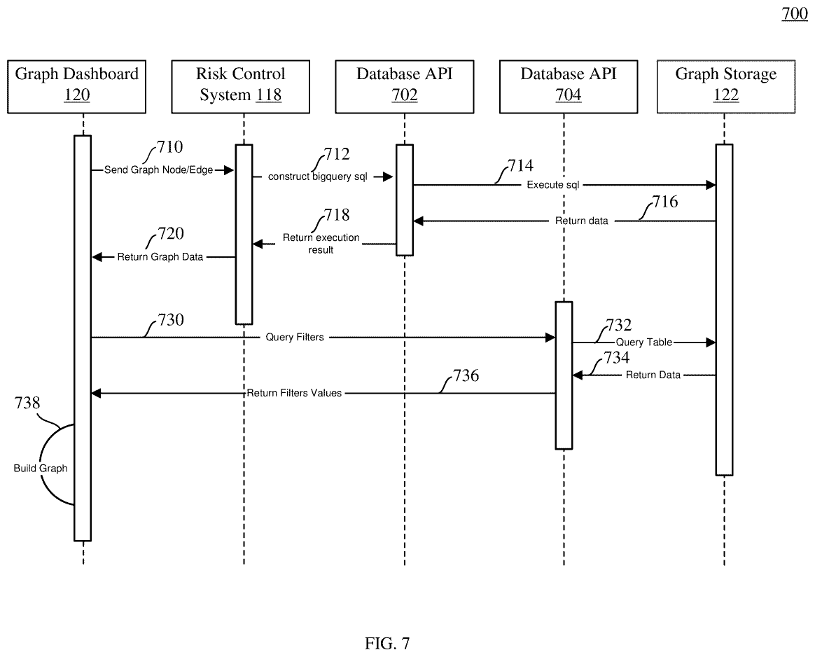

FIG. 7 illustrates a sequence diagram 700 depicting the interaction flow between various components for generating and updating a risk and control graph, according to some embodiments. The sequence diagram 700 shows the step-by-step process from initial request to final graph construction and graph update.

The sequence begins with the graph dashboard 120 making a request 710 to the risk control system 118 to generate graph with nodes and edges. The request 710 may be based on an instruction received via computing device 104S. Upon receiving this request 710, the risk control system 118 constructs a query 712 to retrieve node and edge data from a graph storage 122. In some cases, the risk control system 118 may include a database application programming interface (API) 702. The database API 702 may receive the query 712 and execute the query by issuing request 714 to retrieve the node and edge data from the graph storage 122. After retrieving the data in response 716, the database API 702 returns the node and edge data to the risk control system 118 in response 718.

The risk control system 118 then passes the received node and edge data, along with the node and edge attributes, to the graph dashboard 120 in response 720. Upon receiving the response 720 with the node and edge data and their respective attributes, the graph dashboard 120 generates a graph that includes nodes representing risks and controls and edges connecting the corresponding risks to controls and representing relationships between the risks and controls. In an alternative embodiment, the graph may also be generated by risk control system 118 and transmitted to graph dashboard 120.

In some implementations, computing device 104S may include a database API 704. The database API 704 may act as an intermediary between the graph dashboard 120 and the graph storage 122, facilitating retrieval of information corresponding to a selected node, such as retrieval of risk and control attributes.

When a user interacts with the graph dashboard 120, such as selecting a specific risk node 602 or control node 604, the graph dashboard 120 may send a request 730 to the database API 704 to retrieve additional risk or control attributes. Upon receiving this request 730, the database API 704 may process the request 730 and generate an appropriate query 732 to retrieve the requested information from the graph storage 122. For example, the database API 704 may utilize various query languages or protocols compatible with the graph storage 122 to construct the query 732.

Once the query 732 is generated, the database API 704 may execute it against the graph storage 122. The graph storage 122 may then process the query and return the requested risk or control attributes to the database API 704 in a response 734. Upon receiving the response, the database API 704 may format or transform the information as needed before sending a response 736 back to the graph dashboard 120 to generate a graph or a portion of the graph in operation 738 and display the graph on the graph dashboard 120.

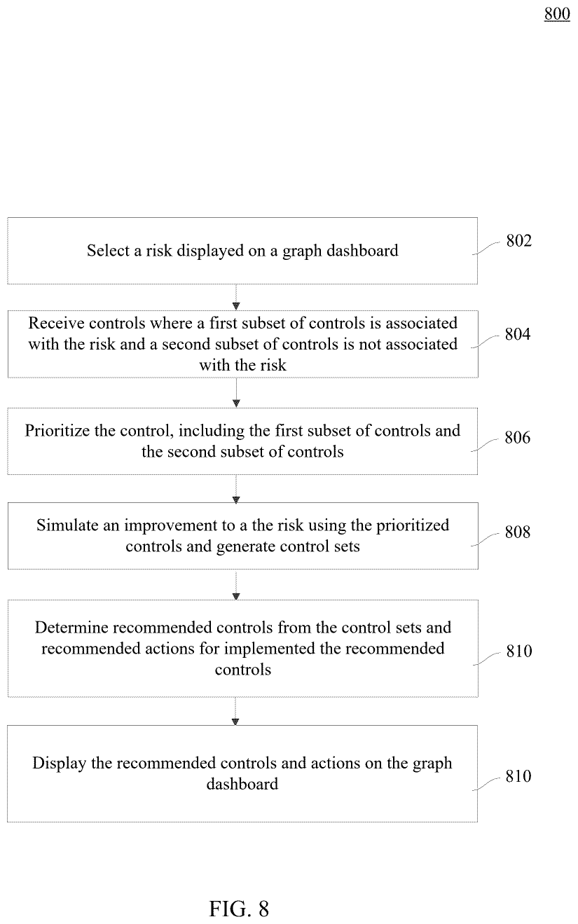

FIG. 8 illustrates a method 800 for mitigating a risk in a computing environment, according to some embodiments. Method 800 may be performed using hardware and/or software components described in FIGS. 1-7. Note that one or more of the operations may be deleted, combined, or performed in a different order as appropriate. Notably, operations 802-810 may occur in real-time or as closely to real-time as technologically possible. Prior to method 800, a graph may be generated and displayed within graph dashboard 120 as discussed in FIG. 7 and illustrated in FIG. 5.

The method 800 may begin with an operation 802 where a risk is selected from a graph dashboard 120. In some cases, the graph dashboard 120 may be displayed on computing device 104S and may present the graph dashboard 500 or graph dashboard 600. A user may interact with the graph dashboard 500 or graph dashboard 600 to select a specific risk node 602 representing the risk to be analyzed.

Following the risk selection, an operation 804 may involve receiving multiple controls. The controls may include a first subset of controls associated with the selected risk and a second subset of controls not associated with the selected risk. For example, suppose risk 202 is selected, then the first subset may include controls 204A, 204B, and 204C directly connected to the risk 202, while the second subset may include controls 204D and 204E that are not directly connected to the risk 202.

At operation 806, the risk control system 118 prioritizes the controls received in operation 804, including controls in both the first subset of controls and the second subset of controls. In some cases, the prioritization may be based on control attributes associated with each control. The control attributes may include a control weight 312 and a control applicability 314 to the risk. The control module 210 may assess these attributes along with other factors such as the number of entities impacted 322, types of entities impacted 324, control design rating 332, control strength 334, and/or control testing 336 to generate the prioritized controls 214.

At operation 808, a simulation occurs to reduce the risk level of the selected risk. The simulation module 212 may perform this simulation by analyzing different combinations of controls from the prioritized controls 214. In some cases, the risk assessment module 410 may evaluate the current risk rating 412 and determine potential new risk ratings 414 by generating various control sets 416 from the prioritized controls 214.

At operation 810, recommended controls and actions to improve the risk rating are determined. This step may involve selecting the most effective control set 416 that achieves the desired risk reduction while considering resource constraints and the cost of implementing each control set in control sets 416. The risk control system 118 may generate recommended controls 216 suggesting specific controls to implement and recommended actions 218 that provide guidance on implementation steps.

At operation 812, recommended controls and actions are displayed. For example, recommended controls 216 and recommended action 218 are transmitted to computing device 104S and are displayed on graph dashboard 120.

Referring now to FIG. 9 an embodiment of a computer system 900 suitable for implementing, the systems and methods described in FIGS. 1-8 is illustrated.

In accordance with various embodiments of the disclosure, computer system 900, such as a computer and/or a server, includes a bus 902 or other communication mechanism for communicating information, which interconnects subsystems and components, such as a processing component 904 (e.g., processor, micro-controller, digital signal processor (DSP), graphics processing unit (GPU), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 918 (e.g., keyboard, keypad, or virtual keyboard), a cursor control component 920 (e.g., mouse, pointer, or trackball), a location determination component 922 (e.g., a Global Positioning System (GPS) device as illustrated, a cell tower triangulation device, and/or a variety of other location determination devices known in the art), and/or a camera component 923. In one implementation, the disk drive component 910 may comprise a database having one or more disk drive components.

Logic may be encoded in a computer readable medium, which may refer to any medium that participates in providing instructions to the processing component 904 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 910, volatile media includes dynamic memory, such as the system memory component 906, and transmission media includes coaxial cables, copper wire, and fiber optics, including wires that comprise the bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 900. In various other embodiments of the disclosure, a plurality of the computer systems 900 coupled by a communication link 924 to the network (e.g., such as a LAN, WLAN, PTSN, and/or various other wired or wireless networks, including telecommunications, mobile, and cellular phone networks) may perform instruction sequences to practice the disclosure in coordination with one another.

The computer system 900 may transmit and receive messages, data, information and instructions, including one or more programs (i.e., application code) through the communication link 924 and the network interface component 912. The network interface component 912 may include an antenna, either separate or integrated, to enable transmission and reception via the communication link 924. Received program code may be executed by processor 904 as received and/or stored in disk drive component 910 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

A number of implementations have been described. Nevertheless, it will be understood that various modifications may be made without departing from the spirit and scope of the disclosure. Accordingly, other implementations are within the scope of the following claims.

A number of implementations have been described. Nevertheless, it will be understood that various modifications may be made without departing from the spirit and scope of the disclosure. Accordingly, other implementations are within the scope of the following claims.

What is claimed is:

1. A risk control system, comprising:
at least one memory; and
at least one processor coupled to the at least one memory and configured to execute instructions that cause the processor to perform operations, the operations comprising:
receive a plurality of controls and a risk associated with a computing environment, wherein the plurality of controls comprise a first subset of controls associated with the risk and a second subset of controls not associated with the risk, and wherein the risk is associated with a risk rating;
prioritize the plurality of controls using a plurality of control attributes corresponding to each control in the plurality of controls;
determine, using a simulation, a plurality of control sets from the plurality of prioritized controls that improve the risk rating; and
select one of the plurality of control sets as a recommended control set to improve the risk rating of the risk.

2. The risk control system of claim 1, wherein the operations further comprise:
generate at least one recommended action corresponding to the recommended control set, wherein the at least one recommended action includes an instruction for implementing the recommended control set.

3. The risk control system of claim 1, wherein the operations to prioritize the plurality of controls further comprise:
assess a weight of each control in the plurality of controls with respect to the risk; and
assess an applicability of the each control in the plurality of controls with respect to the risk.

4. The risk control system of claim 1, wherein the operations to prioritize the plurality of controls further comprise:
assess an impact of each control in the plurality of controls with respect to the computing environment, wherein the impact of the each control corresponds to a number of entities that are associated with the control in the computing environment.

5. The risk control system of claim 1, wherein the operations to prioritize the plurality of controls further comprise:
assess a strength of each control in the plurality of controls for reducing the risk rating of the risk; and
assess a design rating of the each control in the plurality of controls for reducing the risk rating of the risk.

6. The risk control system of claim 1, wherein to determine the plurality of control sets, the operations further comprise:
identify the risk rating of the risk and a new risk rating, wherein the new risk rating improves the risk rating of the risk; and
determine, using control attributes of the plurality of prioritized controls, the plurality of control sets that generate the new risk rating.

7. The risk control system of claim 1, wherein to determine a control set in the plurality of control sets the operations further comprise:
determine a mitigation target between the risk rating for the risk and the new risk rating;
select a control in the plurality of prioritized controls;
determine a number of points by which the selected control lowers the risk rating based on control attributes of the control;
update the risk rating by the number of points;
add the selected control to the control set; and
iteratively repeat previous steps that select another control from the plurality of prioritized controls and add the other control to the control set until the risk rating reaches the mitigation target.

8. The risk control system of claim 1, wherein the operations further comprise:
generate a graph dashboard in a user interface, wherein the graph dashboard displays a node graph with nodes corresponding to the risk and the first subset of controls associated with the risk;
receive input initiating the simulation of the risk; and
display on the graph dashboard the node corresponding to the risk and the recommended control set determined by the simulation.

9. The risk control system of claim 1, wherein the recommended control set mitigates the risk rating of the risk to a new risk rating with a minimum resource allocation in the computing environment to mitigate the risk.

10. A method, comprising:
receiving a selection of a risk from a node graph displayed in a graph dashboard of a user interface, wherein the risk is in a computing environment and is associated with a risk rating;
receiving a plurality of controls associated with the computing environment, wherein the plurality of controls comprise a first subset of controls associated with the risk and a second subset of controls not associated with the risk;
prioritizing the plurality of controls using a plurality of control attributes corresponding to each control in the plurality of controls, wherein the plurality of prioritized controls includes some or all controls in the first subset of controls and the second subset of controls;
determining, using a simulation, a plurality of control sets from the plurality of prioritized controls that improve the risk rating; and
selecting one of the plurality of control sets as a recommended control set to improve the risk rating of the risk.

11. The method of claim 10, further comprising:
generating, using a machine learning system, at least one recommended action corresponding to the recommended control set, wherein the at least one recommended action includes an instruction for implementing the recommended control set.

12. The method of claim 10, wherein to prioritize the plurality of controls, the method further comprises:
assessing a weight of each control in the plurality of controls with respect to the risk; and
assessing an applicability of the each control in the plurality of controls with respect to the risk.

13. The method of claim 10, wherein to prioritize the plurality of controls, the method further comprises:
assessing an impact of each control in the plurality of controls with respect to the computing environment, wherein the impact of each control corresponds to a number of entities that are associated with the control in the computing environment.

14. The method of claim 10, wherein to prioritize the plurality of controls, the method further comprises:
assessing effectiveness of each control in the plurality of controls for reducing the risk rating of the risk.

15. The method of claim 10, wherein to determine the plurality of control sets, the method further comprises:
identifying the risk rating of the risk and a new risk rating, wherein the new risk rating improves the risk rating of the risk; and
determining, using control attributes of the plurality of prioritized controls, the plurality of control sets that generate the new risk rating.

16. The method of claim 10, wherein to determine a control set in the plurality of control sets, the method further comprising:
determining a mitigation target between the risk rating for the risk and the new risk rating;
selecting a control in the plurality of controls;
determining a number of points by which the selected control lowers the risk rating;
lowering the risk rating by the number of points;
adding the selected control to the control set; and
iteratively continuing selecting another control from the plurality of prioritize controls and adding the other control to the control set until the mitigation target is reached.

17. The method of claim 10, further comprising:
generating the graph dashboard in the user interface, wherein the graph dashboard displays the node graph corresponding to the risk and the first subset of controls associated with the risk;
receiving input initiating the simulation of the risk, wherein the input includes the selection of the risk; and
displaying on the graph dashboard the node in the node graph corresponding to the risk and the recommended control set determined by the simulation.

18. A graph visualization system, comprising:
at least one memory; and
at least one processor coupled to the at least one memory and configured to:
generate a node graph comprising a plurality of nodes and edges, wherein the nodes represent risks and controls, the edges represent relationships and weights among the risks and the controls, the risks are associated with a computing environment, and the controls mitigate the risks in the computing environment;
display the node graph on a graph dashboard of a user interface of a computing device;
receive a selection of a node from the node graph, wherein the node corresponds to a risk;
initiate a simulation identifying a recommended control set that reduces a risk rating of the risk to a new risk rating; and
display an updated node graph with the recommended control set for the risk and information associated with at least one control in the recommended control set.

19. The graph visualization system of claim 18, wherein a color of the risk corresponds to the risk rating, wherein the risk is connected to a control by an edge having one of varying thicknesses representing a strength of the control for mitigating the risk rating of the risk.

20. The graph visualization system of claim 19, wherein the at least one processor is further configured to:
receive a plurality of controls including a first subset of control associated with a selected risk and a second subset of controls not associated with the selected risk;
prioritize the plurality of controls using a plurality of control attributes corresponding to each control in the plurality of controls;
determine, using the simulation, a plurality of control sets from the plurality of prioritized controls that improve the risk rating;
select one of the plurality of control sets as the recommended control set to improve the risk rating of the risk; and
provide the recommended control set for display on the graph dashboard.
